(19) United States
(12) Patent Application Publication
(10) Pub. No.: US 2026/0108081 A1
(43) Pub. Date: Apr. 23, 2026

(54) Safety Belt Anchoring Device for Child Seat

(71) Applicant: Yaodong LI, Henan (CN)

(72) Inventor: Yaodong LI, Henan (CN)

(21) Appl. No.: 19/212,058

(22) Filed: May 19, 2025

(30) Foreign Application Priority Data
Oct. 21, 2024 (CN) 202422539495.7

(51) Int. Cl. A47D 15/00; A47D 1/00; B60N 2/26; B60R 22/18

(52) U.S. Cl. CPC A47D 15/006; A47D 1/00; B60N 2/265; B60R 22/18

(57) ABSTRACT

The present disclosure provides a safety belt anchoring device for a child seat, which pertains to the technical field of anchoring devices and comprises a first free end, a second free end, and a first restraint end. The two ends of the first restraint end are connected to one end of the first free end and one end of the second free end, respectively, forming a retention cavity. A second restraint end is disposed on one side of the outer wall of the retention cavity, wherein an accommodating cavity is formed between the first restraint end and the second restraint end.

### CROSS-REFERENCE TO RELATED APPLICATIONS

This application claims priority to Chinese Utility Model Patent Application No. 202422539495.7, titled “Safety Belt Anchoring Device for Child Seat” filed on Oct. 21, 2024, the content of which, including the amendments thereof, are incorporated herein by reference in its entirety.

### TECHNICAL FIELD

The present disclosure relates to the technical field of anchoring devices, particularly to a safety belt anchoring device for a child seat.

### BACKGROUND

In daily life, child seats have become a necessity for every household. Child seats not only provide children with a comfortable resting environment at home but are also equipped with safety belts to protect them during travel.

The existing Chinese Utility Model Patent with a publication number of CN221562868U discloses a safety belt anchoring device for a child seat. The device features two symmetrical receiving components for placing the buckle of the safety belt. However, in practice, even after inserting the buckle into these components, the safety belt webbing may still fold, causing inconvenience for subsequent use. Additionally, this design suffers from poor compatibility, as some buckles of different specifications may be too large or too small to secure properly. For example, U.S. Pat. No. 9,878,642 proposes a safety belt clip, but in practice, it only serves as a guide for car safety belts to protect children and cannot secure the safety belt of the child seat itself.

Therefore, there is a need to propose a safety belt anchoring device for a child seat to address the aforementioned technical issues.

### SUMMARY

The present disclosure provides a safety belt anchoring device for a child seat to solve the problems of the existing devices that the anchored safety belt webbing is prone to folding, affecting subsequent use, and exhibits poor compatibility.

To address these issues, the present disclosure adopts the following technical solutions:

The present disclosure provides a safety belt anchoring device for a child seat, comprising a first free end, a second free end, and a first restraint end. Both ends of the first restraint end are connected to one end of the first free end and one end of the second free end respectively, forming a retention cavity, and a second restraint end is disposed on one side of an outer wall of the retention cavity, wherein an accommodating cavity is formed between the first restraint end and the second restraint end.

Further, a receiving base is disposed on the other side of the outer wall of the retention cavity.

Further, the receiving base is provided with a through hole for receiving a buckle of a safety belt in the child seat.

Further, the first free end, the second free end, and the first restraint end collectively constitute a U-shaped structure.

Further, the first free end, the second free end, the first restraint end, and the second restraint end are all made of elastic materials.

Further, the first restraint end is an arc-shaped structure, and a distance between two ends of the arc-shaped structure in a natural, unstressed state is greater than a distance between the first free end and the second free end.

Further, a bent portion is provided at a tail end of the second restraint end for adjusting a distance between the first restraint end and the second restraint end.

Further, anti-slip protrusions are arranged on an inner wall of the retention cavity.

Further, the retention cavity is configured to accommodate a sidewall of the child seat.

Further, the accommodating cavity is configured for placement of a safety belt webbing.

A safety belt anchoring device for a child seat comprises a first free end, a second free end, and a first restraint end. Both ends of the first restraint end are connected to one end of the first free end and one end of the second free end respectively, and the first free end, the second free end, and the first restraint end jointly enclose to form a retention cavity; and a second restraint end is provided on one side of an outer wall of the retention cavity; and the other side of the outer wall of the retention cavity is provided with a receiving base.

Further, the receiving base is provided with a through hole for receiving a buckle of a safety belt in the child seat.

Further, the first free end, the second free end, and the first restraint end jointly constitute a U-shaped structure.

Further, the first free end, the second free end, the first restraint end, and the second restraint end are all made of elastic materials.

Further, the first restraint end has an arc-shaped structure, and a distance between two ends of the arc-shaped structure in a natural, unstressed state is greater than a distance between the first free end and the second free end.

Further, a bent portion is provided at a tail end of the second restraint end for adjusting a distance between the first restraint end and the second restraint end.

Further, anti-slip protrusions are arranged on an inner wall of the retention cavity.

Further, the retention cavity is configured to accommodate a sidewall of the child seat.

Further, an accommodating cavity is formed between the second restraint end and the first restraint end, and the accommodating cavity is configured for placement of a safety belt webbing.

A method for organizing a safety belt webbing of a child seat using the above safety belt anchoring device for a child seat comprises the following steps:
a) inserting the retention cavity of an anchoring device body into the sidewall of the child seat;
b) threading the safety belt webbing into the accommodating cavity between the second restraint end and the first restraint end; and
c) maintaining the webbing in a flattened state by using an elastic restraint structure to prevent the webbing from folding or twisting.

Compared with the prior art, the beneficial effects achieved by the present disclosure are:

By inserting and securing the safety belt anchoring device into the sidewall of the child seat, the safety belt webbing on the child seat is placed into the accommodating cavity of the safety belt anchoring device. This prevents folding or flipping of the safety belt webbing, is compatible with almost all child seat safety belts to avoid affecting their subsequent use, and can be installed without modifying the original structure of the child seat, offering excellent adaptability.

### BRIEF DESCRIPTION OF DRAWINGS

FIG. 1 is a schematic structural diagram of an anchoring device body in an embodiment provided by the present disclosure;

FIG. 2 is a three-dimensional schematic structural diagram of the anchoring device body in an embodiment provided by the present disclosure;

FIG. 3 is a schematic diagram of anti-slip protrusions in other embodiments of the present disclosure.

In the drawings: Anchoring device body (100); First free end (101); Second free end (102); Retention cavity (103); First restraint end (104); Second restraint end (105); Accommodating cavity (106); Bent portion (107); Receiving base (108); Through hole (109); Inner wall (110); Outer wall (111); Anti-slip protrusion (112).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

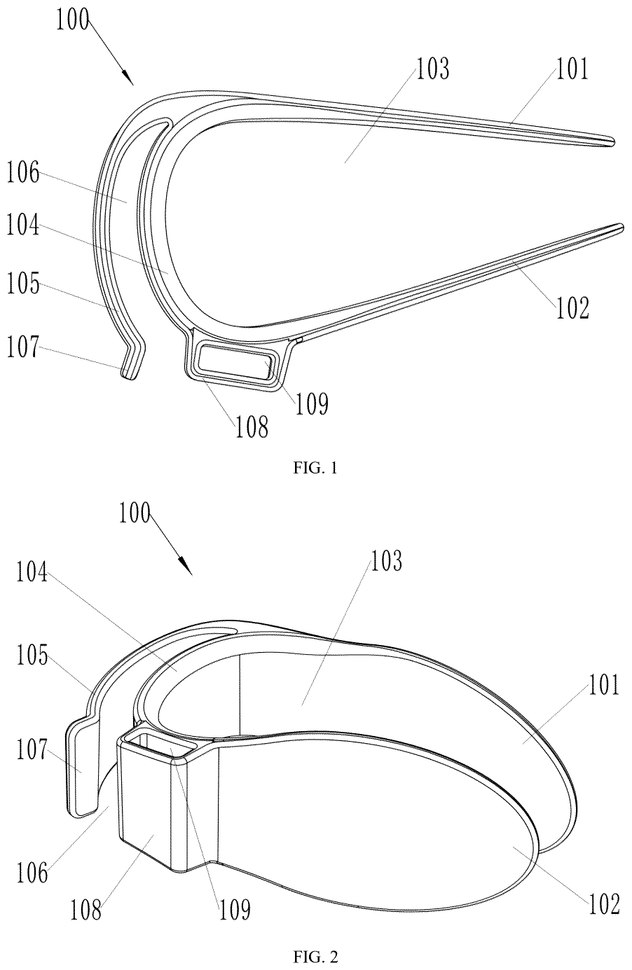

The present disclosure discloses a safety belt anchoring device body 100 applied to a child seat. As shown in FIG. 1, the anchoring device body 100 includes a first free end 101, a second free end 102, and a first restraint end 104. The first free end 101 and the second free end 102 are located on the same side, away from the first restraint end 104. Moreover, both ends of the first restraint end 104 are connected to one end of the first free end 101 and one end of the second free end 102, respectively, forming a retention cavity 103. The first free end 101, the second free end 102, and the first restraint end 104 are integrally formed. The retention cavity 103 accommodates the sidewall of the child seat to secure the anchoring device body 100 to the child seat.

In this embodiment, as shown in FIG. 1, the first free end 101, the second free end 102, and the first restraint end 104 on the anchoring device body 100 form a U-shaped structure. The first restraint end 104 is an arc-shaped structure, and the distance between the two ends of the arc-shaped structure in a natural, unstressed state is greater than the distance between the ends of the first free end 101 and the second free end 102 away from the first restraint end 104. Through the cooperation of the first free end 101 and the second free end 102, the anchoring device body 100 is secured to the child seat, ensuring that the anchoring device body 100 does not fall off.

The outer wall 111 on one side of the U-shaped structure is equipped with a second restraint end 105, while the outer wall 111 on the other side is provided with a receiving base 108. The second restraint end 105 extends from the outer wall 111 of the opposite side of the U-shaped structure, forming an accommodating cavity 106 with the first restraint end 104 to receive the seat belt webbing. This accommodating cavity 106 is used to place the seat belt webbing, facilitating the positioning and storage of the seat belt. Placing the seat belt webbing in the accommodating cavity 106 prevents folding or flipping of the belt, making seat belt usage simpler and more convenient during travel while enhancing safety. It is also compatible with different brands and models, offering good universality.

A bent portion 107 is provided at the tail end of the second restraint end 105, leaving only space in the accommodating cavity 106 for the seat belt webbing. The addition of the bent portion 107 enlarges the entry point for the seat belt, allowing the seat belt to pass through the bent portion 107 into the interior of the accommodating cavity 106 for storage.

In other embodiments (not shown), there are two or more first restraint ends 104, and each of the two or more first restraint ends 104 is connected to the first free end 101 and the second free end 102. The two or more first restraint ends 104 are assembled via insertion, buckle, screws, or adhesive.

In other embodiments (not shown), the second restraint end 105 extends from an outer wall 111 on one side of the U-shaped structure to the outer wall 111 on the opposite side, forming a closed accommodating cavity 106. The buckle of the seat belt and seat belt webbing can pass through the accommodating cavity 106, ensuring the seat belt webbing remains inside the accommodating cavity 106 without folding or flipping.

In other embodiments (not shown), a plurality of receiving bases 108 are also arranged on the outer wall 111 of the U-shaped structure, or they can be configured in any other desired quantity.

In other embodiments (not shown), hook-and-loop fasteners are provided on the opposing sides of the first free end 101 and the second free end 102. After inserting the anchoring device body 100 into the sidewall of the child seat, a tight connection with the child seat is achieved via the hook-and-loop fasteners, thereby improving the stability of the anchoring device body 100.

In other embodiments (not shown), both ends of the first restraint end 104 are equipped with arc-shaped second restraint ends 105, with a certain gap between two second restraint ends 105. The seat belt webbing can pass through this gap, so that the seat belt webbing remains within the accommodating cavity 106 without folding or flipping.

In other embodiments (not shown), the first free end 101, the second free end 102, and the first restraint end 104 on the anchoring device body 100 jointly form a trapezoidal structure. The length of the trapezoidal structure's base is greater than that of its top, and the top is open to facilitate the entry of the sidewall of the child seat. Additionally, the two sides of the trapezoidal structure angle inward relative to the base, enabling the anchoring device body 100 to be more stably fixed to the sidewall of the child seat without easily falling off.

In other embodiments (not shown), bidirectional wedge-shaped sliders are arranged inside the U-shaped structure, with two sets of 45° inclined sliders symmetrically distributed along the slide rail of the inner wall 110. When inserted into the seat sidewall, the sliders are compressed and slide along the guide rail, generating a clamping force. Silicone dampers are equipped to control the sliding speed and prevent impact rebound.

In other embodiments (not shown), the first restraint end 104 adopts a three-segment hinge design, and the U-shaped structure can be folded into a planar state through a 180° rotation.

In other embodiments (not shown), the anchoring device body 100 is composed of two or more parts assembled via insertion, buckles, screws, or adhesive.

In other embodiments (not shown), a piezoelectric vibration sensor is integrated inside the accommodating cavity 106. When abnormal seatbelt vibrations are detected, a miniature electromagnetic lock is activated. If the anomaly persists for 3 seconds, an LED indicator light issues a warning.

In other embodiments (not shown), a spiral fine-tuning device is installed on the second restraint end 105, utilizing fine threads to achieve precise adjustment and protect the seat belt webbing.

In other embodiments (not shown), the first free end 101, the second free end 102, and the first restraint end 104 jointly form a C-shaped structure.

In other embodiments (not shown), the first free end 101, the second free end 102, and the first restraint end 104 jointly form a V-shaped structure.

In this embodiment, the first free end 101, the second free end 102, the first restraint end 104, and the second restraint end 105 on the anchoring device body 100 are all made of elastic materials. This elastic material has the property of returning to its original shape after external force is applied, enabling the anchoring device body 100 to adapt to child seat sidewalls of various shapes and sizes. Additionally, elastic materials often exhibit excellent durability, resisting wear from daily use and extending the product's lifespan.

The elastic material used is a metallic elastic material. Specifically, the anchoring device body 100 can be made of aluminum alloy. Aluminum alloy is a lightweight elastic material with excellent elastic properties. Moreover, aluminum alloy has good heat resistance and high strength, which can enhance the performance of this anchoring device. Additionally, the anchoring device body 100 can also be made of rigid polymer elastic materials, such as silicone, which provide durability. The anchoring device body 100 can also be made of soft elastic materials, such as rubber, which offer good flexibility and comfort, making it suitable for scenarios requiring a soft touch.

In other embodiments (not shown), a titanium alloy mesh liner is embedded at key stress points (the root of the first free end 101) to improve fatigue life.

In other embodiments (not shown), the first free end 101, second free end 102, first restraint end 104, and second restraint end 105 on the anchoring device body 100 are all made of rigid materials. Rigid materials offer good stability, are less prone to deformation, and enhance safety.

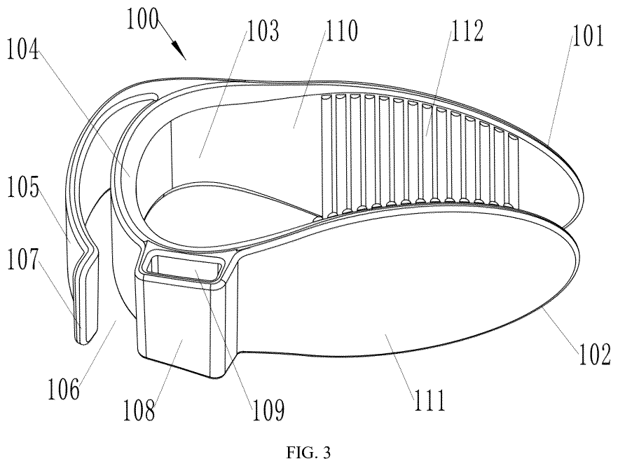

In this embodiment, as shown in FIG. 3, several anti-slip protrusions 112 are arranged on the inner walls 110 on both sides of the retention cavity 103. These anti-slip protrusions 112 can increase friction, preventing objects from sliding or moving during use, thereby improving safety. At the same time, the anti-slip protrusions 112 also provide additional stability, preventing objects from rolling or moving on uneven surfaces.

In other embodiments (not shown), anti-slip textures can also be arranged on the inner walls 110 of the retention cavity 103. The anti-slip textures have anti-slip properties, preventing the anchoring device body 100 from sliding or moving during use, thereby enhancing safety.

In other embodiments (not shown), a spring may also be arranged inside the retention cavity 103. This spring can automatically adjust the accommodating space of the retention cavity 103, thereby adapting to the sidewall dimensions of different models of child seats.

In other embodiments (not shown), a sliding mechanism may also be provided inside the retention cavity 103. Users can adjust the accommodating space of the retention cavity 103 by sliding this mechanism according to the sidewall dimensions of the child seat, thereby securing the safety belt more firmly and preventing loosening or slipping.

In other embodiments, as shown in FIG. 3, the receiving base 108 has a trapezoidal platform structure. The four corners of this trapezoidal platform are chamfered. This chamfering removes sharp edges, preventing users from being cut during operation and thereby improving the product's safety.

In other embodiments (not shown), the receiving base 108 may have not only a rectangular platform structure but also a circular platform structure.

In this embodiment, as shown in FIG. 2, the receiving base 108 is provided with a through hole 109, which is used to receive the buckle of the safety belt, thereby securing the safety belt inside the anchoring device body 100 and positioning the belt on one side of the safety seat. At the same time, the sidewalls on both sides of the child seat are equipped with safety belt anchoring devices. Placing the buckles of the belts on both sides into the anchoring devices positions the belts on either side of the seat, preventing them from scattering on the child seat and making it more comfortable for the child to sit.

In other embodiments (not shown), the receiving base 108 is internally provided with a groove that receives and secures the buckle of the safety belt. The connection between the buckle and the groove ensures the belt is fixed more firmly, making it less prone to loosening or detachment.

In other embodiments (not shown), a rotating protective cover is installed at the entrance of the through hole 109, featuring a dual ratchet mechanism that requires pressing both unlock buttons simultaneously to open, and it cannot be operated single-handedly by a child.

In other embodiments (not shown), a magnet is placed at the entrance of the through hole 109. When the buckle of the safety belt is inserted into the through hole 109, it is further secured by the magnetic attraction of the magnet, preventing the buckle from loosening.

In other embodiments (not shown), an extension is made on any part of the outer side of the anchoring device body 100. The extension and the outer wall 111 of the anchoring device body 100 form an accommodating cavity 106 to secure the safety belt.

A method for organizing the safety belt webbing of a child seat using the aforementioned safety belt anchoring device for a child seat, includes the following steps:
a) inserting the retention cavity 103 of an anchoring device body 100 into the sidewall of the child seat;
b) threading the safety belt webbing into the accommodating cavity 106 between the second restraint end 105 and the first restraint end 104; and
c) maintaining the webbing in a flattened state by using an elastic restraint structure to prevent the webbing from folding or twisting.

In summary, the present disclosure achieves the following technical effects:

By inserting and securing the anchoring device body 100 of the safety belt anchoring device into the sidewall of the child seat, the safety belt webbing on the child seat is placed into the accommodating cavity 106 on the anchoring device body 100. This prevents folding or flipping of the safety belt webbing; it is also compatible with nearly all child seat safety belts to avoid issues during subsequent use, and requires no modification to the original structure of the child seat for installation, offering excellent adaptability.

It should be noted that the anchoring device body 100 of the present disclosure is not only suitable for child car safety seats but also applicable to other devices equipped with shoulder straps, such as baby strollers, child dining chairs, and travel seats.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

1. A safety belt anchoring device for a child seat, comprising a first free end, a second free end, and a first restraint end, wherein both ends of the first restraint end are connected to one end of the first free end and one end of the second free end respectively, forming a retention cavity, and a second restraint end is disposed on one side of an outer wall of the retention cavity; wherein the retention cavity is configured to accommodate a sidewall of the child seat; and
wherein an accommodating cavity is formed between the first restraint end and the second restraint end.

2. The safety belt anchoring device for a child seat according to claim 1, wherein a receiving base is disposed on another side of the outer wall of the retention cavity.

3. The safety belt anchoring device for a child seat according to claim 2, wherein the receiving base is provided with a through hole configured for receiving a buckle of a safety belt in the child seat.

4. The safety belt anchoring device for a child seat according to claim 1, wherein the first free end, the second free end, and the first restraint end collectively constitute a U-shaped structure.

5. The safety belt anchoring device for a child seat according to claim 1, wherein the first free end, the second free end, the first restraint end, and the second restraint end are all made of elastic materials.

6. The safety belt anchoring device for a child seat according to claim 1, wherein the first restraint end is an arc-shaped structure, and a distance between two ends of the arc-shaped structure in a natural, unstressed state is greater than a distance between the first free end and the second free end.

7. The safety belt anchoring device for a child seat according to claim 1, wherein a bent portion is provided at a tail end of the second restraint end for adjusting a distance between the first restraint end and the second restraint end.

8. The safety belt anchoring device for a child seat according to claim 1, wherein anti-slip protrusions are arranged on an inner wall of the retention cavity.

9. (canceled)

10. The safety belt anchoring device for a child seat according to claim 1, wherein the accommodating cavity is configured for placement of a safety belt webbing.

11. A safety belt anchoring device for a child seat, comprising a first free end, a second free end, and a first restraint end, wherein both ends of the first restraint end are connected to one end of the first free end and one end of the second free end respectively, and the first free end, the second free end, and the first restraint end jointly enclose to form a retention cavity; and
a second restraint end is provided on one side of an outer wall of the retention cavity;
another side of the outer wall of the retention cavity is provided with a receiving base; and
wherein an accommodating cavity is formed between the second restraint end and the first restraint end, and the accommodating cavity is configured for placement of a safety belt webbing.

12. The safety belt anchoring device for a child seat according to claim 11, wherein the receiving base is provided with a through hole configured for receiving a buckle of a safety belt in the child seat.

13. The safety belt anchoring device for a child seat according to claim 11, wherein the first free end, the second free end, and the first restraint end jointly constitute a U-shaped structure.

14. The safety belt anchoring device for a child seat according to claim 11, wherein the first free end, the second free end, the first restraint end, and the second restraint end are all made of elastic materials.

15. The safety belt anchoring device for a child seat according to claim 11, wherein the first restraint end has an arc-shaped structure, and a distance between two ends of the arc-shaped structure in a natural, unstressed state is greater than a distance between the first free end and the second free end.

16. The safety belt anchoring device for a child seat according to claim 11, wherein a bent portion is provided at a tail end of the second restraint end for adjusting a distance between the first restraint end and the second restraint end.

17. The safety belt anchoring device for a child seat according to claim 11, wherein anti-slip protrusions are arranged on an inner wall of the retention cavity.

18. The safety belt anchoring device for a child seat according to claim 11, wherein the retention cavity is configured to accommodate a sidewall of the child seat.

19. (canceled)

20. A method for organizing a safety belt webbing of a child seat, comprising the following steps:
a) providing an anchoring device comprising:
i) a first free end, a second free end, and a first restraint end, wherein both ends of the first restraint end are connected to one end of the first free end and one end of the second free end respectively, forming a retention cavity; and
ii) a second restraint end is disposed on one side of an outer wall of the retention cavity wherein a receiving base is disposed on the other side of the outer wall of the retention cavity;
wherein an accommodating cavity is formed between the first restraint end and the second restraint end
b) providing a child seat;
c) inserting the retention cavity of the anchoring device body into the sidewall of the child seat;
d) threading safety belt webbing into the accommodating cavity between the second restraint end and the first restraint end; and
e) maintaining the safety belt webbing in a flattened state by using an elastic restraint structure to prevent the webbing from folding or twisting.
